(19) United States
(12) Patent Application Publication
(10) Pub. No.: US 2009/0156273 A1
(43) Pub. Date: Jun. 18, 2009

(54) Loudspeaker for a Clamshell Wireless Communication Device

(75) Inventors: Eric Douglas Romesburg, Chapel Hill, NC (US); William Chris Eaton, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/956,953

(22) Filed: Dec. 14, 2007

(51) Int. Cl. H04M 1/00

(52) U.S. Cl. 455/575.3; 381/332

(57) ABSTRACT

A clamshell-type wireless communication device has a flip, a base, and a hinge that pivotably connects the flip to the base. The flip pivots relative to the base between an open position and a closed position. An earpiece speaker in the flip renders the voice of a remote party to a user when the flip is in the open position. A loudspeaker within the hinge also renders audible sound to the user. The loudspeaker is positioned within the hinge such that neither the flip nor the base obstructs the audible sound projected by the loudspeaker regardless of whether the flip is in the open position or the closed position.

### FIELD OF THE INVENTION

The present invention relates generally to wireless communication devices, and particularly to clamshell-type wireless communication devices having a loudspeaker.

### BACKGROUND

Most cellular telephones have more than one speaker. Typically, one of the speakers is an earpiece speaker that renders a remote party's voice to a user during a conversation. The other is a loudspeaker that is spaced away from the earpiece speaker. The loudspeaker is usually employed to render alert tones and music to the user, and in some cases, permits the user to employ the cellular telephone as a speakerphone.

Clamshell-type cellular telephones typically have “rear-facing” loudspeakers. That is, the loudspeaker is oriented within a housing of the clamshell cellular telephone such that it projects audible sound through an audio port formed in a rear of the housing and away from the user. Directing audio away from the user may degrade sound quality as perceived by the user. Therefore, rear-facing loudspeakers are not ideal. To combat this, some manufacturers design their clamshell housings especially to port the “rear-projected” audio to the front of the housing.

For example, the MOTOROLA i95 model of cellular telephones utilizes a rear-facing electrodynamic speaker placed within the housing. A pair of curved audio passages is integrally-formed with the housing, and terminates in respective audio ports formed in on opposite sides of the keypad. The passages direct the audible sound rendered by the rear-facing loudspeaker towards the front and side of the cellular telephone.

However, even with these audio passages, sound quality may suffer. Additionally, the audio passages increase the dimensions of the cellular telephone. A design that would allow a clamshell cellular telephone to include front-facing speakers would be beneficial.

### SUMMARY

In one embodiment, a clamshell-type wireless communication device comprises a flip, a base, and a hinge that pivotably connects the flip to the base. The flip pivots relative to the base between an open position and a closed position, and includes an earpiece speaker. The earpiece speaker renders audible sound to a user when the flip is in the open position. A loudspeaker is positioned within the hinge and renders audible sound such as music or alert tones to the user. The loudspeaker is positioned such that neither the flip nor the base obstructs the audible sound projected by the loudspeaker regardless of whether the flip is in the open position or the closed position.

### BRIEF DESCRIPTION OF THE DRAWINGS

FIGS. 1A-1B illustrate the front of a clamshell-type cellular telephone in open and closed positions, respectively. The clamshell cellular telephone is shown having a loudspeaker positioned within the hinge according to one embodiment of the present invention.

FIGS. 1C-1D illustrate the rear of the clamshell-type cellular telephone of FIGS. 1A-1B in open and closed positions.

FIGS. 2A-2C illustrate an exemplary loudspeaker that is suitable for use in one embodiment of the present invention.

FIG. 3A-3B illustrate a side sectional view of a hinge for a clamshell-type cellular telephone according to one embodiment of the present invention in open and closed positions.

FIGS. 4A and 4B illustrate a clamshell-type cellular telephone in open and closed positions, respectively. The clamshell cellular telephone is shown having a pair of loudspeakers positioned within the hinge according to another embodiment of the present invention.

FIGS. 5A and 5B illustrate a clamshell-type cellular telephone in open and closed positions, respectively. The clamshell cellular telephone is shown having a loudspeaker positioned within the hinge according to another embodiment of the present invention.

FIG. 6A-6B illustrate a side sectional view of a hinge for a clamshell-type cellular telephone according to another embodiment of the present invention in open and closed positions.

### DETAILED DESCRIPTION

The present invention contemplates the placement of a loudspeaker for a clamshell-type wireless communication device that has a flip, a base, and a hinge. The hinge pivotably connects the flip and the base such that the flip pivots relative to the base between open and closed positions. In one embodiment, the device includes an earpiece speaker within the flip and a loudspeaker within the hinge. The earpiece speaker renders a remote party's voice to a user, while the loudspeaker renders audible sounds, such as music or alert tones, for example. According to the present invention, the loudspeaker is “front-facing.” That is, the loudspeaker is oriented within the hinge such that it projects audible sound to a “front” of the device regardless of whether the flip is open or closed. Further, neither the flip nor the base obstructs or blocks the audible sound projected by the loudspeaker regardless of whether the flip is in the open position or the closed position.

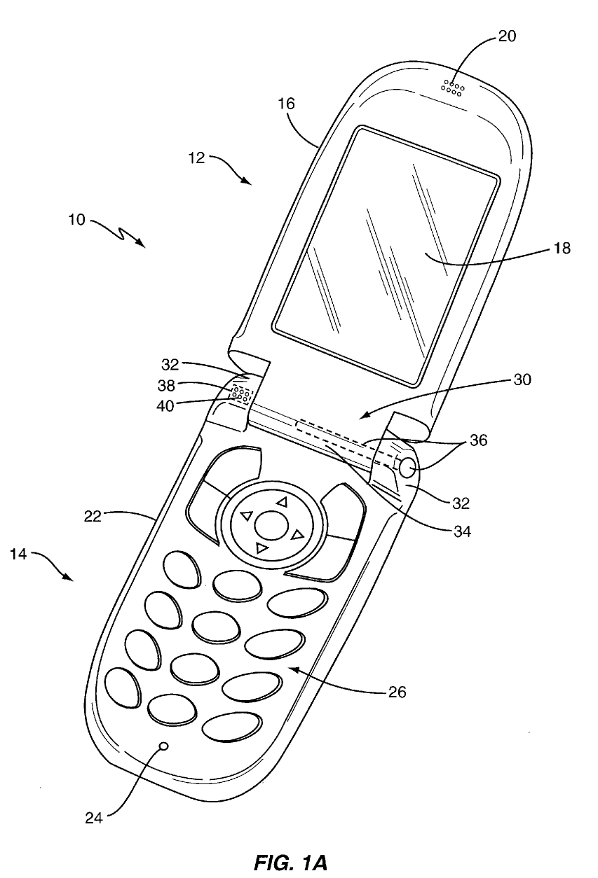

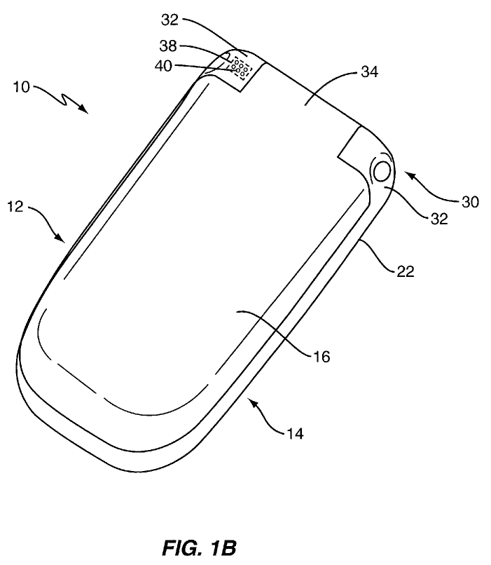

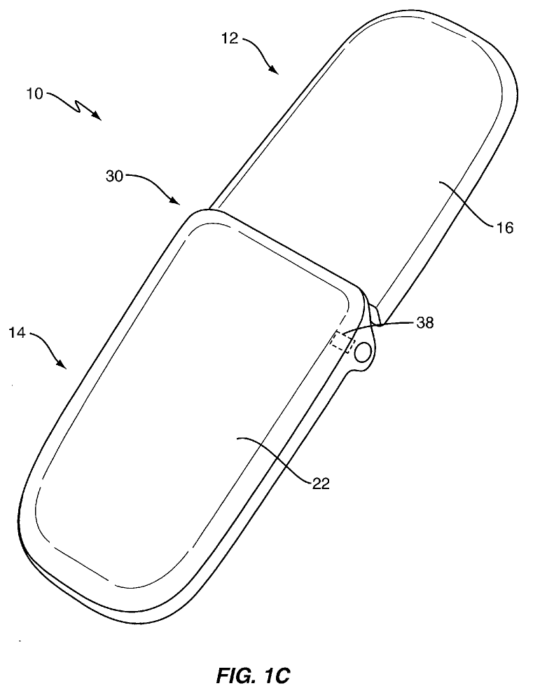

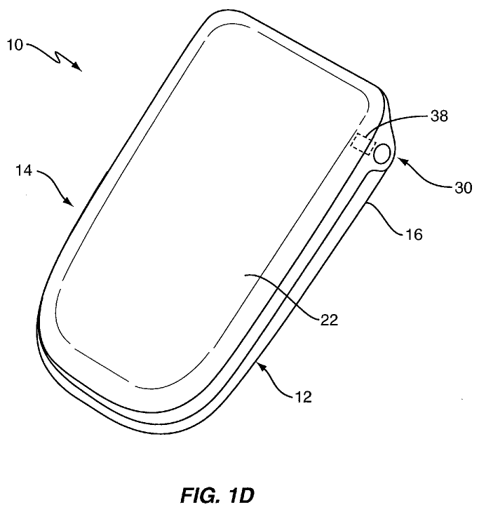

FIGS. 1A-1D are perspective views that illustrate a clamshell-type wireless communication device configured according to one embodiment of the present invention. FIGS. 1A and 1B illustrate what is referred to as a “front” of the device (i.e., how a user would view the device from the front), while FIGS. 1C and 1D illustrate what is referred to as the “back” or the “rear” of the device. The clamshell wireless communication device shown in the figures comprises a “flip-phone;” however, this is for illustrative purposes only. The present invention may be employed in other types of clamshell-type devices.

Flip-phone 10 has a flip 12, a base 14, and a hinge 30 that pivotably connects the flip 12 to the base 14. The hinge 30 permits a user to pivot the flip 12 relative to the base 14 between an open position (FIG. 1A) and a closed position (FIG. 1B). In the open position, the user may place and receive voice and data calls, while in the closed position, the user may be alerted to incoming calls or listen to music.

Generally, flip 12 comprises a housing 16 that contains a display 18, an earpiece speaker 20, and at least some of the electronic circuitry associated with these components. Display 18 may be, for example, a liquid crystal display (LCD) or a touchscreen display that displays information such as menu items and status messages to the user. Earpiece speaker 20 usually comprises a electrodynamic speaker that converts received audio signals into audible sound that the user can hear. Typically, the received audio signals represent the voice of a remote party with whom the user is conversing. An audio processing circuit (not shown) placed in base 14 usually processes the received audio signals using methods well-known in the art.

Base 14 also includes a housing 22 that contains, inter alia, a microphone 24 and user interface controls 26. Microphone 24 converts audible sounds into audio signals for input to the audio processing circuit. Those signals may then be sent to one or more remote parties via a communication interface (not shown) such as a cellular transceiver, for example. The user interface controls 26 typically comprises a keyboard, a keypad, a scroll wheel, a touch pad, or a trackball, but may comprise other suitable user input devices. The user may press selected keys or operate selected controls on user interface controls 26 to select menu items, enter phone numbers, or otherwise enter commands to control the operation of flip-phone 10. Where display 18 is a touchscreen display, display 18 may also function as a part of user interface controls 26.

Hinge 30 comprises a fixed part 32 and a movable part 34, each of which comprises a hollow sleeve. In this embodiment, the movable part 34 is integrally formed with the housing of flip 12, while the fixed part 32 is integrally formed with the housing on either side of base 14. As seen in the figures, the movable part 34 is sized to fit between the two opposing ends of the fixed part 32. A hinge pin 36 extends through the interior of the fixed and movable parts 32, 34 to interconnect the flip 12 to the base 14 in a pivotable relationship. When the flip 12 moves between the open and closed positions, the movable part 34 pivots with the flip 12 about the hinge pin 36.

Hinge 30 also comprises a speaker positioned within the interior of the fixed part 32, and an audio port 40 integrally formed in the fixed part 32. In this embodiment, the speaker positioned within hinge 30 comprises a flat-panel speaker 38, such as a piezoelectric speaker for example. However, the present invention does not require the use of a flat-panel speaker 38. As seen in more detail later, electrodynamic speakers may be placed in hinge 30 in lieu of a flat-panel speaker 38.

In this embodiment, the flat-panel speaker 38 electrically connects to the audio processing circuit in base 14 to receive audio signals. The flat-panel speaker 38 then converts the audio signals into audible sound and renders it to the user. With the present invention, the flat-panel speaker 38 may be used to render audible sound such as alert tones or music to the user. In some cases, the user may employ the flat-panel speaker 38 to render a remote party's voice when the user employs flip-phone 10 as a speakerphone.

As seen in FIGS. 1A-1B, the flat-panel speaker 38 is a “front-facing” loudspeaker. That is, the present invention orients the flat-panel speaker 38 within the fixed part 32 of hinge 30 such that at least one sound-producing surface directs audible sound toward the front of flip-phone 10 regardless of whether the flip-phone 10 is open (FIG. 1A) or closed (FIG. 1B). This allows the flat-panel speaker 38 to render “unobstructed” audible sound to the user. Neither the flip 12 nor the base 14 block or otherwise interfere with the sound waves generated by flat-panel speaker 38 regardless of whether the flip 12 is in the open position or the closed position.

Disposing the flat-panel speaker 38 within the hinge 30 as in the present invention provides benefits not realized by conventional flip-phones that have rear-facing loudspeakers. For example, an unobstructed front-facing loudspeaker maximizes perceived loudness and sound quality because it does not have to rely on a room reflecting the sound waves to the user, as do conventional flip-phones. Additionally, it removes the strong coupling between the placements of flat-panel speaker 38 and microphone 24 on base 14. This allows a manufacturer the freedom to position the microphone 24 nearer to a user's mouth to minimize the amount of background noise microphone 24 might pick up. Further, it allows manufacturers to minimize the size dimensions of flip-phone 10. In addition, the same microphone 24 may be used both when the flip 12 is in the open position and the closed position. Negating the need for additional components reduces costs and complexity.

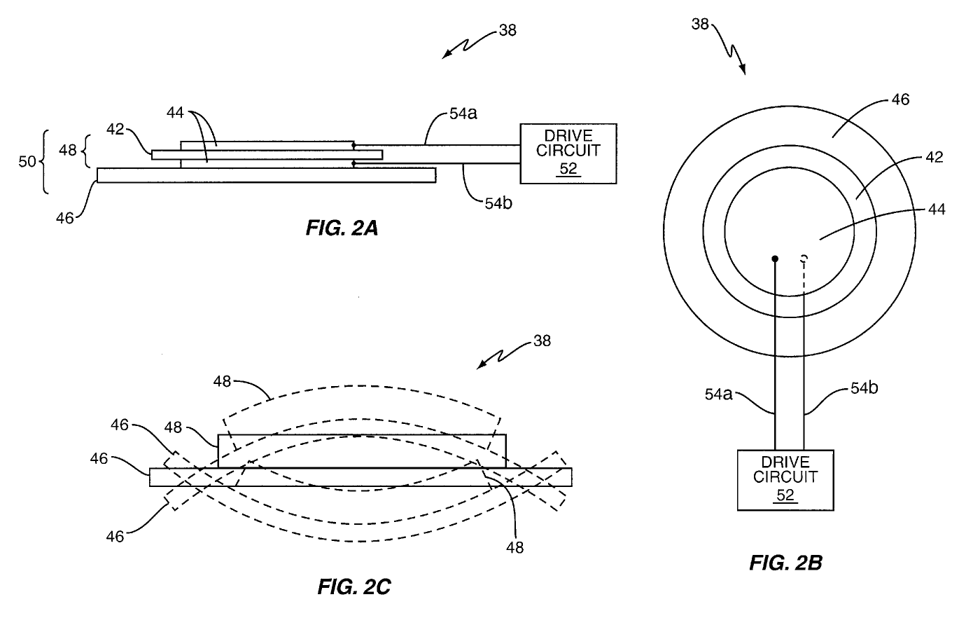

As previously stated, the flat-panel speaker 38 may be any speaker known in the art. Suitable speakers include, but are not limited to, dynamic-moving coil speakers, ribbon speakers, electrostatic speakers, air motion transformer speakers, and distributed mode loudspeakers. However, in one embodiment, seen in FIGS. 2A-2C, flat-panel speaker 38 comprises a piezoelectric speaker. One particularly suitable piezoelectric speaker is model number BX-070093 (Type-F) manufactured by MURATA Manufacturing Co., Ltd.

The structure and operation of piezoelectric speakers are well-known in the art; however, a brief description is included here for completeness. As seen in FIGS. 2A (side view) and 2B (top view), flat-panel speaker 38 comprises a piezoelectric ceramic plate 42 sandwiched between a pair of electrodes 44. The ceramic plate 42 and the electrodes 44 form a piezoelectric element 48 that binds to a metallic base plate 46 using any of a variety of adhesives known in the art. Typically, base plate 46 is constructed of brass or stainless steel, but other metals or alloys may also be suitable. Together, the ceramic plate 42, the electrodes 44, and the base plate 46 comprise a piezoelectric diaphragm 50.

A drive circuit 52, which may be within the housing 22 of base 14, attaches to the electrodes 44 on both sides of the ceramic plate 42 via lead wires 54a, 54b. In operation, the drive circuit 52 delivers a voltage representing an audio signal to the electrodes 44. This voltage causes the piezoelectric element 48 to expand and shrink. When the piezoelectric element 48 expands or shrinks, the piezoelectric diaphragm 50 bends as shown in FIG. 2C. Repeatedly applying the voltage to the electrodes 44 thereby causes the piezoelectric diaphragm 50 to oscillate and produce the audible sound waves heard by a user.

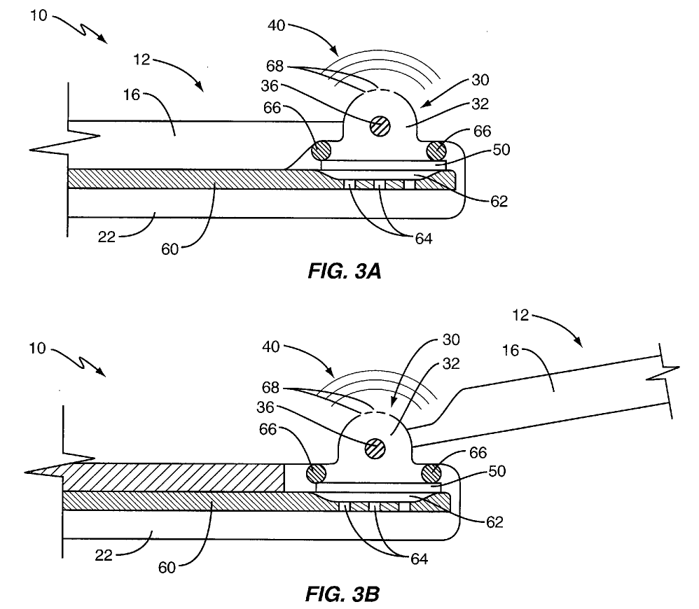

FIGS. 3A-3B illustrate how the flat-panel speaker 38 such as a piezoelectric diaphragm 50 could be mounted within the hinge 30 according to one embodiment of the present invention. Particularly, the diaphragm 50 emits audible sound through audio port 40 and to the front of the flip-phone 10 regardless of whether the flip 12 is in the open position (FIG. 3A) or the closed position (FIG. 3B). No part of the structure of flip 12 or base 14 obstructs or interferes with the audible sound after it has been rendered through port 40.

The diaphragm 50 may mount to a surface of a printed circuit board (PCB) 60 placed within the fixed part 32 of hinge 30. Mounting the diaphragm 50 to PCB 60 may be accomplished using any method known in the art. However, U.S. patent application Ser. No. ______ filed on ______, 200_ and entitled “Printed Circuit Board for a Flat-Panel Speaker,” describes a suitable method for mounting the flat-panel speaker 38 within the fixed part 32 of hinge 30. The entirety of the '______ application is expressly incorporated herein by reference.

To briefly summarize, the '______ application describes forming PCB 60 with an acoustic chamber 62 and one or more channels 64. Generally, acoustic chamber 62 comprises a space or volume that is adjacent the diaphragm 50 and the PCB 60. The acoustic chamber 62 may be formed as a recess, for example, in which all or a part of the recess extends at least partially through the interior of PCB 60. The chamber 62 allows the diaphragm 50 room to flex when it generates audible sound. The channels 64 comprise one or more through-holes extending through the interior of PCB 60. The channels 64 connect the acoustic chamber 62 to an opposing side of PCB 60, and allow displaced air to escape from the chamber 62 when the diaphragm 50 flexes. This reduces the possibility of over-compression of the diaphragm 50 when it flexes to generate audible sound.

The diaphragm 50 attaches to the surface of PCB 60 using adhesives or solder, or by any other method known in the art. In addition, a gasket 66 is placed between the diaphragm 50 and the inner wall of the fixed part 32 of hinge 30 to acoustically seal the diaphragm 50. Audible sound generated by the diaphragm 50 travels through openings 68 of audio port 40 and to the front of the flip-phone 10.

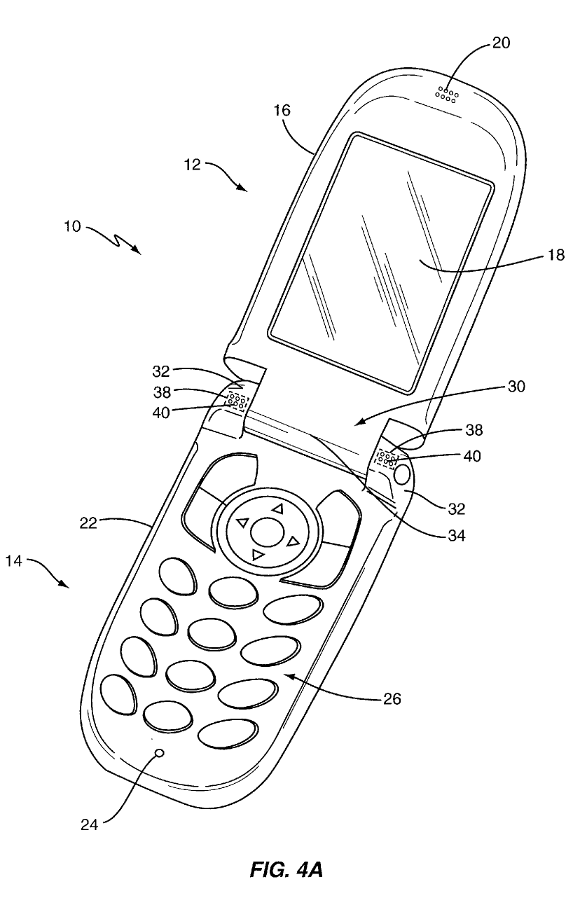

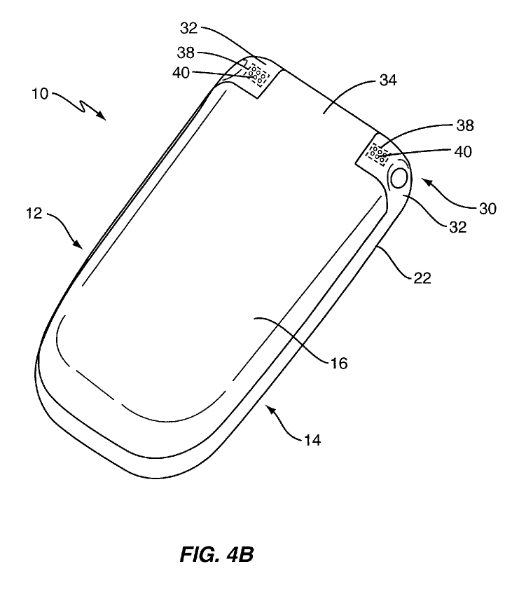

FIGS. 4A-4B illustrate another embodiment of the present invention in which a pair of flat-panel speakers 38 are placed in the fixed part 32 of hinge 30. Particularly, both flat-panel speakers 38 electrically connect to one or more drive circuits 52 in base 14. The flat-panel speakers 38 are front-facing and spatially separated such that there is one loudspeaker on each side of hinge 30. This permits the flat-panel speakers 38 to render stereo sound to the user when the flip is open (FIG. 4A) or closed (FIG. 4B). As in the previous embodiment, the placement and orientation of the flat-panel speakers 38 is such that neither the flip 12 nor the base 14 obstructs or interferes with the sound waves generated by flat-panel speakers 38 after the sound waves pass through their respective audio ports 40.

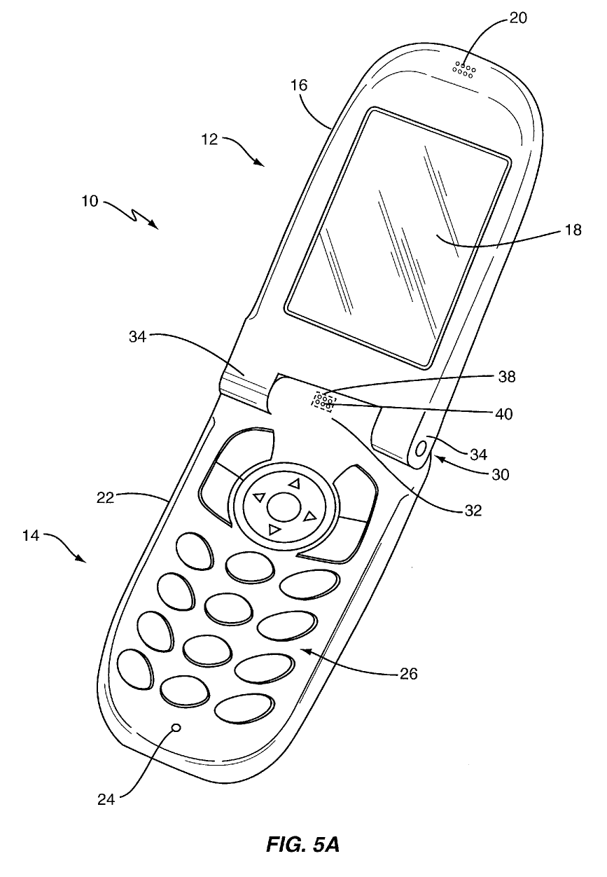

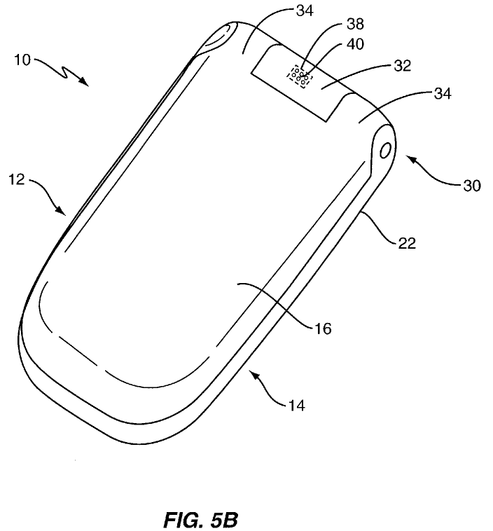

FIGS. 5A and 5B illustrate another embodiment of the present invention with an alternate placement for flat-panel speaker 38. In this embodiment, the fixed part 32 of hinge 30 is integrally-formed with the base 14, and the movable part 34 is integrally-formed with flip 12. The flat-panel speaker 38 is within the fixed part 32 such that it is front-facing and generally centrally located along the length of hinge 30. Flat-panel speaker 38 is oriented such that it outputs audible sound to the user regardless of whether the flip 12 is in the open position (FIG. 5A) or the closed position (FIG. 5B). Additionally, neither the flip 12 nor the base 14 obstructs or interferes with the sound waves generated by flat-panel speakers 38 after the sound waves pass through port 40.

The previous embodiments discuss the present invention in terms of using a flat-panel speaker 38 within hinge 30. As previously stated, however, this is for illustrative purposes only. The present invention is not limited to the use of a flat-panel speaker 38, but can use other types of dynamic moving coil speakers as well. For example, electrodynamic speakers are also equally as suitable for placement within hinge 30.

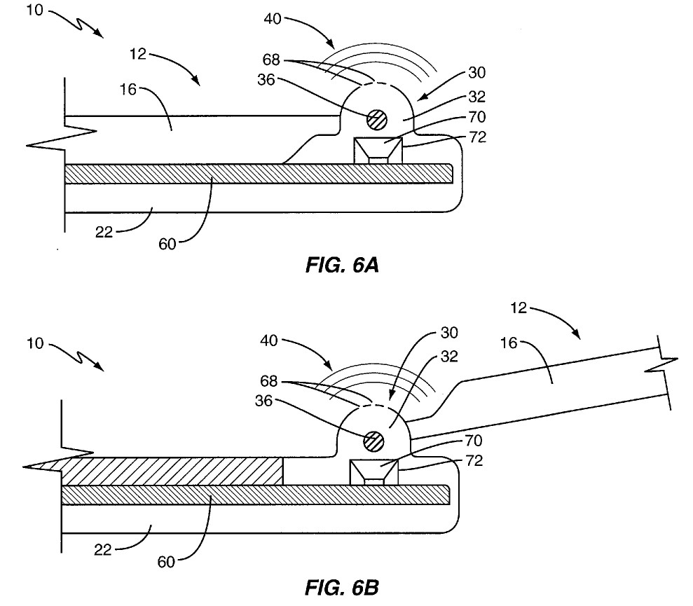

FIGS. 6A-6B illustrate how an electrodynamic speaker 70 could be mounted within the hinge 30 according to another embodiment of the present invention. Particularly, the electrodynamic speaker 70 is “front-facing” such that the speaker 70 emits audible sound through audio port 40 and to the front of the flip-phone 10 regardless of whether the flip 12 is in the open position (FIG. 6A) or the closed position (FIG. 6B). The speaker 70 may be mounted in a sealed chamber, such as a speaker box 72, for example, to help prevent acoustic echo. As in the previous embodiments, however, no part of the structure of flip 12 or base 14 obstructs or interferes with the audible sound after it has been rendered through port 40.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A clamshell-type wireless communication device comprising:
a base;
a flip pivotably connected to the base, and movable relative to the base between an open position and a closed position;
a hinge to pivotably connect the flip to the base; and
a speaker positioned within the hinge and configured to project audible sound at a user.

2. The wireless communication device of claim 1 wherein the speaker is configured to project audible sound at the user when the flip is in either the open position or the closed position.

3. The wireless communication device of claim 2 further comprising a keypad that faces the user when the flip is in the open position, and that is covered by the flip when the flip is in the closed position.

4. The wireless communication device of claim 2 further comprising an earpiece speaker within a housing of the flip, the earpiece speaker being configured to render audible sound at the user when the flip is in the open position, but not the closed position.

5. The wireless communication device of claim 1 wherein the hinge comprises a fixed portion and a movable portion, and wherein the speaker is positioned within the fixed portion.

6. The wireless communication device of claim 5 wherein the fixed portion is integrally formed with the base.

7. The wireless communication device of claim 6 wherein the fixed portion is integrally formed with the flip.

8. The wireless communication device of claim 5 further comprising a speaker port integrally formed on the fixed portion of the hinge such that the speaker port directs the audible sound at the user when the flip is in the open position and the closed position.

9. The wireless communication device of claim 1 wherein the speaker comprises a first speaker and a second speaker, both being positioned within the hinge and spaced away from each other such that the first and second speakers project stereo sound at the user.

10. The wireless communication device of claim 9 wherein the first speaker and the second speaker project stereo sound at the user when the flip is in the open position and the closed position.

11. A method of rendering audible sound to a user of a clamshell-type wireless communication device, the method comprising:
pivotably connecting a flip to a base, such that the flip pivots relative to the base about a hinge between an open position and a closed position;
positioning a speaker within the hinge to project audible sound at a user.

12. The method of claim 11 wherein positioning a speaker within the hinge comprises positioning the speaker to project audible sound from the hinge when the flip is in the open position and the closed position.

13. The method of claim 12 further comprising forming a speaker port in the hinge to project the audible sound at the user when the flip is in the open position and the closed position.

14. The method of claim 11 wherein the hinge comprises a fixed portion and a movable portion, and wherein positioning a speaker within the hinge to project audible sound at a user comprises positioning the speaker within the fixed portion of the hinge.

15. The method of claim 14 wherein the fixed portion is integrally formed with the base.

16. The method of claim 14 wherein the fixed portion is integrally formed with the flip.

17. The method of claim 11 wherein positioning a speaker within the hinge comprises positioning first and second speakers within the hinge to project stereo sound at the user.

18. The method of claim 17 further comprising positioning the first and second speakers within the hinge such that the first and second speakers project stereo sound at the user regardless of whether the flip is in the open position or in the closed position.

19. The method of claim 11 further comprising disposing an earpiece speaker within a housing of the flip such that the earpiece speaker renders audible sound to the user when the flip is in the open position, but not the closed position.
